(19) United States
(12) Patent Application Publication
(10) Pub. No.: US 2026/0270205 A1
(43) Pub. Date: Sep. 10, 2026

(54) FLOW CONTROL INPUT PREDICTION FOR SATELLITE BASED INTERNET SERVICE

(71) Applicant: Hughes Network Systems, LLC, Germantown, MD (US)

(72) Inventors: Fernando SECALI DE OLIVEIRA FILHO, Derwood, MD (US); Venkatasubramaniam GANESAN, Germantown, MD (US); Hsui-Chu HUANG, Derwood, MD (US)

(73) Assignee: Hughes Network Systems, LLC, Germantown, MD (US)

(21) Appl. No.: 19/070,539

(22) Filed: Mar. 5, 2025

(51) Int. Cl. H04L 47/127; H04B 7/185; H04L 41/0896; H04L 41/16; H04L 47/24

(52) U.S. Cl. CPC H04L 47/127; H04B 7/18515; H04L 41/0896; H04L 41/16; H04L 47/24

(57) ABSTRACT

In a satellite communication system, a method and system for proactive bandwidth allocation are introduced. The method involves collecting data from input producers and a flow controller, tracking real-time traffic inputs, and predicting future network traffic patterns using a Flow Control Input Farseer (FCIF) model. This model is trained with historical traffic data and utilizes neural networks such as RNNs, LSTMs, and CNNs. The system includes a Farseer Agent (FA) for data collection, input producers for tracking traffic, and a flow controller for bandwidth assignment based on predicted traffic patterns. The FCIF model is refined by a trainer and incorporates feature engineering and attention mechanisms to enhance prediction accuracy. The system also includes an input aggregator for managing traffic reports and bandwidth requests.

### FIELD

The present teachings are related to communication networks that use gateway hardware and software elements including a flow controller for utilizing machine learning for predictive bandwidth allocation. In particular, teachings provide traffic pattern prediction on both download and upload direction in a satellite communication network.

### BACKGROUND

Satellite Internet Service Providers (ISPs) face a multitude of challenges, including increased demand for bandwidth and low-latency performance from a growing number of distinct customer networks. The satellite ISPs operate under a lower capacity ceiling than traditional ground-based ISPs and traffic management via bandwidth allocation maintains quality service.

Prior art flow control mechanisms typically rely on real-time inputs to manage bandwidth distribution among users. As such, bandwidth allocation is adjusted based on a current state of demand or congestion at a particular moment and suffers from degraded performance when operating on outdated or stale data. Without an ability to predict future demand, congestion or high demand occurs before adjustment. This leads to slower reactions and misses opportunities for proactive management. Moreover, when network conditions change rapidly, such as during sudden surges or drops in demand, the reactive nature of the prior art results in inefficient bandwidth management, where over- or under-allocation of bandwidth may occur.

In satellite communication systems, especially those using geostationary satellites, there is a significant round-trip time (RTT) delay due to the distance between the satellite and the ground. This delay can range from 240 milliseconds to 600 milliseconds, depending on the system. On top of RTT delay, the flow control inputs are based on assumptions on queue occupation. There is an extra processing delay between the queue getting filled and the flow controllers acting. As a result, the current flow control algorithms often operate on outdated or stale data when making bandwidth allocation decisions. The outdated data causes the algorithm to make bandwidth allocation decisions based on information that is no longer accurate. This can lead to inefficient bandwidth distribution, where some users may be over-allocated bandwidth while others experience congestion. Moreover, as flow control decisions are based on stale data, users may experience higher latency, reduced throughput, or even service interruptions during periods of high demand or congestion.

Moreover, the prior art lacks any predictive mechanism to forecast network conditions. These systems rely solely on immediate, real-time inputs to adjust bandwidth allocation, without considering what traffic patterns might occur. Without predictive capabilities, the prior art system is unable to proactively allocate resources based on forecasted network conditions. This is particularly problematic in satellite networks where traffic demand can vary significantly across time and regions. Also, when there are sudden spikes or dips in traffic, the system cannot forecast and respond efficiently. The lack of prediction leads to poor management of bandwidth resources, which directly impacts the overall performance and reliability of the network.

To address these challenges, the present teachings disclose a Flow Control Input Farseer (FCIF) including an AI-enhanced flow control input predictor. The FCIF may use a Machine Learning (ML) model to predict traffic inputs to the flow controller, allowing for more accurate and timely bandwidth allocation.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

A Flow Control Input Farseer (FCIF) provides proactive bandwidth allocation for a satellite ISP by using a Machine Learning (ML) model to predict demand and provide flow control inputs based on the predicted demand. FCIF may be integrated into an existing flow control architecture. FCIF may predict or forecast future demands on the network by analyzing historical traffic patterns and real-time data. FCIF includes a data-collecting agent, a Farseer Agent (FA), deployed in networks to gather traffic information. In some embodiments, FCIF includes a centralized trainer to train the ML model to predict flow control inputs. The centralized trainer may pre-process the data collected by the FA prior to training the ML.

FCIF predicts flow control inputs to predict a demand before the flow control inputs are received by the flow controller, allowing for the flow controller to adjust bandwidth assignments based on predicted traffic patterns rather than on potentially outdated real-time data.

A method for proactive bandwidth allocation in a satellite communication system may involve a Farseer Agent (FA) collecting data from input producers and a flow controller. The data can include timestamps of traffic inputs, real-time inputs at each flow control cycle, outputs generated by the flow controller, and network conditions. The input producers may track real-time traffic inputs and capture data at a higher frequency than a flow controller cycle. A Flow Control Input Farseer (FCIF) model can predict future network traffic patterns and flow control inputs based on the collected data. The FCIF model may be trained using historical traffic data and can employ some examples of recurrent neural networks (RNNs), long short-term memory (LSTM) networks, and convolutional neural networks (CNNs). A trainer may develop and refine the FCIF model capable of inferring and predicting the future flow control inputs. The flow controller can assign bandwidth to terminals based on the predicted future network traffic patterns and flow control inputs.

A system for proactive bandwidth allocation in a satellite communication system may include a Farseer Agent (FA) configured to collect data from input producers and a flow controller. The data can include timestamps of traffic inputs, real-time inputs at each flow control cycle, outputs generated by the flow controller, and network conditions. Input producers may track real-time traffic inputs and capture data at a higher frequency than a flow controller cycle. A Flow Control Input Farseer (FCIF) model can predict future network traffic patterns and flow control inputs based on the collected data. The FCIF model may be trained using historical traffic data and can employ some examples of recurrent neural networks (RNNs), long short-term memory (LSTM) networks, and convolutional neural networks (CNNs). A trainer may develop and refine the FCIF model capable of inferring and predicting the future flow control inputs. A flow controller can assign bandwidth to terminals based on the predicted future network traffic patterns and flow control inputs.

The method may consider network conditions that can include delay, jitter, and packet loss. The FA can timestamp and merge the data from the input producers and the flow controller to create a synchronized dataset for training the FCIF model. The FCIF model may apply feature engineering to extract features from the collected data, which can include demand trends, anomalies in traffic patterns, seasonal variations, and correlations between inputs and flow control outputs. The FCIF model can incorporate an attention mechanism to focus on relevant portions of the input data when making predictions. The trainer may perform initial training of the FCIF model in a non-production network and deploy the trained FCIF model to the FA in a production network. The flow controller can determine an anticipated demand based on some examples of deep packet inspection (DPI) and examination of an upper layer connection type. The input producers may include some examples of a terminal, an IP gateway, and nodes on the Internet. The flow controller can receive some examples of a predicted demand, an anticipated demand, and an advertised demand for bandwidth allocation.

The system may consider network conditions that can include delay, jitter, and packet loss. The FA can be further configured to timestamp and merge the data from the input producers and the flow controller to create a synchronized dataset for training the FCIF model. The FCIF model may be further configured to apply feature engineering to extract features from the collected data, which can include demand trends, anomalies in traffic patterns, seasonal variations, and correlations between inputs and flow control outputs. The FCIF model can incorporate an attention mechanism to focus on relevant portions of the input data when making predictions. The trainer may be further configured to perform initial training of the FCIF model in a non-production network and deploy the trained FCIF model to the FA in a production network.

The flow controller can be further configured to determine an anticipated demand based on some examples of deep packet inspection (DPI) and examination of an upper layer connection type. The system may further comprise an input aggregator configured to aggregate reported traffic, split bandwidth assignment, and request bandwidth from the flow controller. The input aggregator can comprise a Carrier Rate Organizer (CRO) for aggregating the reported traffic and splitting the bandwidth assignment.

Additional features will be set forth in the description that follows, and in part will be apparent from the description, or may be learned by practice of what is described.

### BRIEF DESCRIPTION OF DRAWINGS

In order to describe the manner in which the above-recited and other advantages and features may be obtained, a more particular description is provided below and will be rendered by reference to specific embodiments thereof which are illustrated in the appended drawings. Understanding that these drawings depict only typical embodiments and are not, therefore, to be limiting of its scope, implementations will be described and explained with additional specificity and detail with the accompanying drawings.

FIG. 1 illustrates a satellite communication system, according to various embodiments.

FIG. 2 is an exemplary functional framework for an AI/ML model according to various embodiments.

FIG. 3 illustrates a conceptual system of a Flow Control system according to various embodiments.

FIG. 4 illustrates a method for optimizing network traffic management through predictive modeling and data collection according to various embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The present teachings may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

### Introduction

The present teachings may be extended to communication networks utilizing gateway hardware and software elements for data transportation. For instance, it could be integrated into satellite communication systems or broadband services operating within communication networks employing gateway hardware and software elements similar to a satellite communications network.

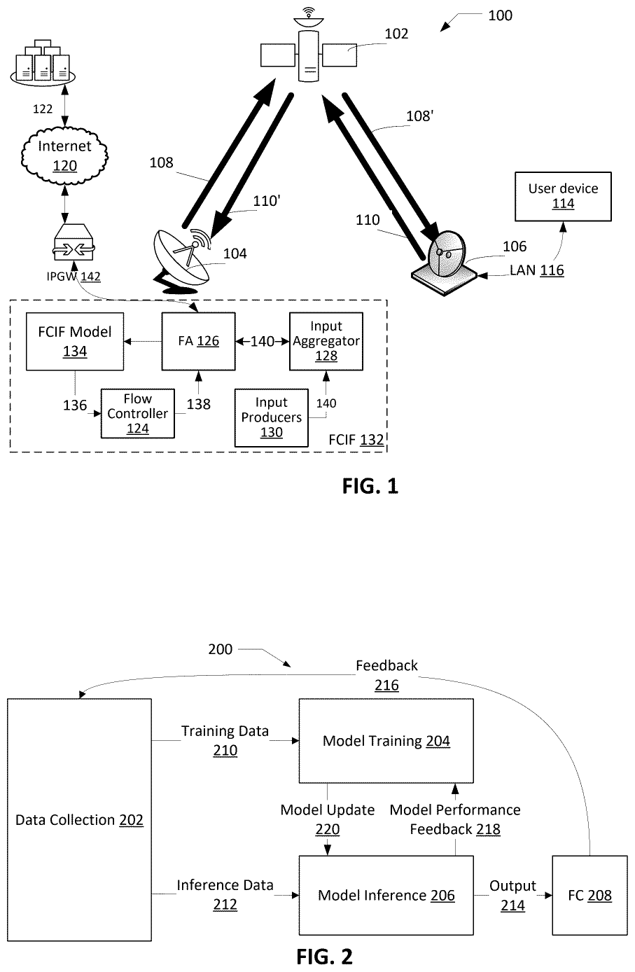

FIG. 1 illustrates a satellite communication system, according to various embodiments.

A satellite system 100 uses Time Division Multiple Access (TDMA) on a frequency channel between a gateway 104 and terminal 106. TDMA is a digital modulation technique that allows a terminal population to share the same frequency channel by dividing the signal into different timeslots that may be further divided into symbols and bits using a flow controller 124. Communication from the gateway 104 to the terminal 106 is via an outroute that includes an uplink 108 from the gateway 104 to satellite 102. Satellite 102 relays communications as a downlink 108′ to the terminal 106. Communication from the terminal 106 to the gateway 104 is via an inroute that includes an uplink 110 from the terminal 106 relayed by the satellite 102 as a downlink 110′ to the gateway 104. Gateway 104 may be terrestrially connected to internet 120 where a server 122 resides. The terminal 106 may be connected to a user device 114 via LAN 116. User device 114 connects to server 122 via the LAN 116 to the terminal 106 to the satellite 102 to the gateway 104 to internet 120.

Gateway 104 includes a flow controller 124 including a Farseer Agent (FA) 126, an input aggregator 128 and input producers 130. Exemplary input producers 130 include terminal 106, an IPGW 142 (IP Gateway), nodes on the internet 120, or the like.

The input aggregator 128 includes sub-systems that aggregate reported traffic and split bandwidth assignment, for example, a Carrier Rate Organizer (CRO). The input aggregator 128 may cycle its data in a cycle that is identical/equal to a flow controller cycle. The input aggregator 128 requests bandwidth from flow controller 124 for the inroute or an outroute. Terminal 106 may include an input producer (not shown). The input aggregator 128 may be viewed as a special input producer that provides input per the flow controller cycle. The input aggregator provides data 140 (such as aggregate reported traffic and split bandwidth assignment to FA 126).

The flow controller 124 assigns bandwidth based on the demand from various user terminals operating within a frequency channel. Several user needs are balanced during bandwidth distribution. Data from various user terminals is transmitted in bursts according to their allocated time slots. The flow controller allocates bandwidth in bursts at specific times for active user terminals.

Allocation of bandwidth may be based on a predicted demand (outroute or inroute) for a terminal 106 sent by FA 126 to flow controller 124. Besides the predicted demand, flow controller 124 may receive an anticipated demand and an advertised demand. In some embodiments, flow controller 124 determines the anticipated demand, on an inroute or an outroute, based on Deep Packet Inspection (DPI), examination of an upper layer connection type or the like. In some embodiments, DPI may be performed on gateway 104 and information gleaned about a connection may be sent/collected by one of the input producers 130.

### Flow Control Input Farseer

Flow control challenges for satellite ISPs include varying customer demands, capacity limitations, delay in flow control execution, reactive nature, inability to predict and the like. For example, as customer networks increase and decrease in size and complexity over time, their throughput and latency requirements vary correspondingly. Also, due to the hardware constraints of satellites, ISPs have a lower capacity ceiling than traditional ground-based ISPs. Moreover, flow control inputs are subject to network delays and packet processing overhead. Consequently, flow control processes often operate on stale data, resulting in suboptimal bandwidth distribution. Typically, traditional flow control processes rely heavily on real-time feedback to make decisions about bandwidth allocation. They operate reactively, adjusting the bandwidth distribution based on the current demand or congestion conditions. As a result, they cannot proactively manage bandwidth based on future demand. Lastly, traditional systems do not incorporate predictive mechanisms, limiting their ability to forecast future traffic patterns. They only respond to current traffic conditions, which makes them inefficient in managing sudden spikes or dips in network demand.

The present teachings disclose a flow controller including a Flow Control Input Farseer (FCIF) 132 to address these challenges by predicting future flow control inputs using Machine Learning (ML) to provide a predicted demand for bandwidth allocation. The FCIF 132 allows flow controller 124 to proactively adjust bandwidth allocation based on predicted future traffic patterns. The FCIF 132 performs input data collection, and data timestamping and merging.

For input data collection, the FCIF 132 collects data from two primary sources, namely, input producers 130 and the flow controller 124. Input Producers 130 include network devices or systems that track real-time traffic inputs. Input producers 130 may capture data 140 more frequently than a flow control cycle of the flow controller 124, for example, three or more times faster data capture at an input producer compared to the flow controller cycle. For example, input producers may track real-time traffic inputs as data 140 at a higher frequency (such as 20 ms) than a flow controller cycle (such as 100 ms).

In some embodiments, input data collection includes data 138 from flow controller 124. For input data collection in the FCIF 132, flow controller 124 provides data 138 including the inputs used and the outputs generated therefrom during flow control cycles. In some embodiments, flow controller 124 sends the data 138 to input aggregator 128 rather than FA 126.

For data timestamping and merging, the data 140 from the input producers 130 and the data 138 from flow controller 124 is timestamped and merged by the FA 126. This creates a synchronized dataset that can be used for model training. The synchronized includes:
Timestamp
Input at the time of collection
Input at the time of flow control execution
Flow controller output

The FCIF 132 includes a FCIF model 134 to predict future network traffic patterns and flow control inputs. The FCIF model 134 includes a supervised learning system trained offline on historical traffic data using real-time inputs from Input Producers, and flow control outputs. An output data 136 including a predicted demand per unit inferred by the FCIF model 134 is provided to the flow controller 124.

An input layer of the FCIF model receives the traffic data, including time-stamped inputs from Input Producers and Flow Controllers. These inputs represent the demand on the network, real-time usage, and other parameters such as latency, packet loss, or throughput that are tracked over time.

### ML Model Architecture

FIG. 2 is an exemplary functional framework for a FCIF model according to various embodiments.

A framework 200 for a FCIF model may include a data collection module 202. Data collection module 202 provides input or training data 210 to a Model Training module 204 and a Model inference module 206. Examples of training data 210 include data from input aggregators (not shown), input producers (not shown) and a flow controller (not shown). Training data 210 includes data needed as input for Model training module 204. Model training module 204 may include an AI/ML function. Data collection module 202 may provide inference data 212 as input for the Model inference module 206.

Model Training module 204 performs the AI/ML model training, validation, and testing. Model inference module 206 may generate model performance metrics or feedback 218 as part of the model testing procedure. Model deployment/update 220 may be used to initially deploy a trained, validated, and tested FCIF model to the Model Inference module 206 or to deliver an updated model to the Model Inference module 206.

Model Inference module 206 provides FCIF model inference output. Model Inference module 206 may provide a Model Performance Feedback 218 to model training module 204 when applicable. Model performance feedback 218 may be for monitoring the performance of the FCIF model, when available. Feedback 218 may be used to derive training data, inference data or to monitor the performance of the FCIF Model and its impact to the network through updating of KPIs and performance counters. In some embodiments, model Inference module 206 may use the FCIL model to produce an output 214. Output 214 may include a predicted demand per unit.

Flow controller 208 receives the output 214 from the Model Inference module 206 and triggers or performs corresponding actions, for example, assigning bandwidth per unit based on the predicted demand.

To ensure high prediction accuracy, the FCIF model applies feature engineering to the collected data. Prominent features are extracted, such as: Demand trends over various intervals, Anomalies in traffic patterns (e.g., sudden surges), Seasonal variations (e.g., peak usage times during the day), and Correlations between inputs and flow control outputs. These features are then used to construct a dataset that allows the ML to learn patterns in the data including patterns that are not immediately apparent.

Hidden layers of the FCIF model process the engineered features to identify complex relationships between input patterns and flow control behavior. The FCIF model includes recurrent neural networks (RNNs), long short-term memory (LSTM) networks and convolutional neural networks (CNN), which are well-suited for sequential data and time-series predictions. These architectures allow the ML model to capture both short-term variations and long-term dependencies in traffic patterns.

LSTM networks can maintain “memory” of past events. This provides accurately predicting future inputs, as network demand often depends on prior traffic behaviors. LSTMs can identify long-range dependencies in traffic, which may span several flow control cycles. CNN networks are typically used for image processing but can also be effective for time series data. CNNs may be trained faster compared to LSTM while still providing reasonable accuracy.

In addition to LSTMs and CNNs, the FCIF model may incorporate an attention mechanism to focus on the most relevant portions of the input data when making predictions. This allows the model to weigh important traffic features (e.g., significant spikes or drops in demand) more heavily than less important patterns. The attention mechanism improves prediction accuracy, especially in scenarios where traffic conditions rapidly change or deviate from historical norms.

An output layer of the model produces a prediction of the traffic input that will be received by the flow controller at the next execution cycle. This prediction includes Future demand on the network, Estimated usage levels across the customer base and Expected input-to-output relationships, helping the flow controller make better-informed decisions about bandwidth allocation.

### Training Data and Process

The training phase develops a predictive model. The FCIF model is trained using historical data collected by the FA from both Input Producers and the Flow Controller. The FA data sources include input producers (Devices or systems that generate traffic in real-time), input Aggregators (devices that aggregate reported traffic and split bandwidth assignment) and a flow controller (system responsible for executing flow control, which includes both the input received and the flow controller's output).

The Data Collected includes timestamps of when traffic inputs were generated, real-time inputs at each flow control cycle, outputs generated by the flow controller, and latency and network conditions (for example, delay, jitter, or packet loss) that might influence the flow control process. The training data includes a large volume of time-stamped input and output data across multiple customer networks, which is merged into a synchronized dataset by the FA. The data collected or captured by the FA generates a dataset including timestamps and associated data points. The dataset may be used for training the FCIF model. The training dataset includes traffic inputs from T1 and T2, the output at T3, and all relevant network conditions. The timestamps include
T1 (input at the moment traffic is generated).
T2 (when the flow controller receives the input).
T3 (when the flow controller processes the input of T1).

During a learning phase, FA 126 consolidates and forwards the synchronized dataset to a Trainer. The Trainer uses this data to develop and refine a FCIF model 134 capable of inferring and predicting future flow control inputs. Initial training is performed in a non-production network, for example, a test network. After training, the FCIF model 134 is deployed to a FA in the production network. The FA then uses a trained FCIF model 134 to predict flow control inputs in real-time. The predicted flow control inputs are then fed into the flow controller. The flow controller than allocates bandwidth to the terminals based on the predicted flow control inputs.

### Example of Flow Control Input Prediction

In the following example, a flow control cycle executes in a 100-millisecond interval. At T1 (0 msec), flow control inputs are sent by individual devices. At T2 (40 msec), flow control inputs are received by the flow controller 40 milliseconds later due to network delays or the like. At T3 (41 msec), the flow controller executes using inputs that are already 40 milliseconds old, leading to degraded performance.

Using the Flow Control Input Farseer, the flow controller can predict the inputs at T2 before T2, and adjust bandwidth assignments proactively prior to T3, even though the actual data is delayed. This improves overall system performance and customer experience.

### Supervised Learning Approach

The FCIF model may employ a supervised learning approach, where the model learns to map the inputs (T1, T2, network conditions) to the desired outputs (T3, flow control outputs). The learning process involves minimizing the difference between the predicted inputs and the actual inputs received by the flow.

### The System of Distributive Flow Control

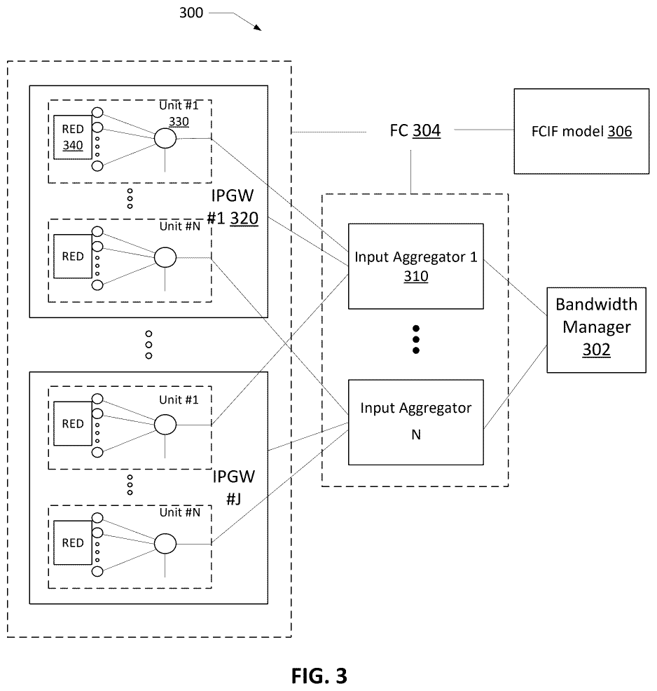

FIG. 3 illustrates a conceptual system of a Flow Controller (FC) according to various embodiments.

A flow controller system 300 may be provided input by multiple input aggregators 310 (or CROs) that each get inputs from multiple-IP Gateways (IPGWs) 320. Input aggregators 310 may provide an advertised demand and/or an anticipated demand per unit 330. The unit 330 may be a communications route. The unit 330 may be segregated per priority in a communication system. In some embodiments, the unit 330 may be segregated per VNO per priority.

A FCIF model 306 may output a predicted demand per unit 306. The output of the FCIF model 306 and an output of the input aggregators 310 is received by FC 304 may receive input from a FCIF model 306.FC 304 may assign bandwidth per unit 330. FC 304 may work together or be integrated with a Bandwidth Manager 302. Bandwidth manager 302 may allocate bandwidth per unit. The allocated bandwidth may be changed from the assigned bandwidth based on considerations other than flow control. Output of the FC 304 may be based on resource allocation and functions, such as, backlog report, scheduling, and TCP congestion control, to provide distributed congestion control with high stability in the flow controller system 300. In exemplary embodiments, the FC 304 output may be based on the backlog report, scheduling, TCP congestion control, and predicted demand. In exemplary embodiments, generic functions at the IPGW 320 and an input aggregator 310 may be implemented as disclosed in U.S. Pat. Nos. 8,929,217 and 8,705,357 using multiple processing threads that run in parallel.

The Bandwidth Manager 302 receives/collects information of the demand and bandwidth assignment at run-time to make decisions. For example, the BM 302 may reallocate and balance a capacity, if needed. Bandwidth allocation by the FC 304, revised or adjusted by the BM 302, is sent to the IPGWs 320 for flow control purpose. The IPGW 320 may run flow control, such as, demand calculation, scheduling and TCP congestion control based on Random Early Detection (RED) 340, for terminals (terminal sessions). In exemplary embodiments, the IPGW 320 may group terminals by the input aggregator 310 that they connect with.

### Exemplary Method

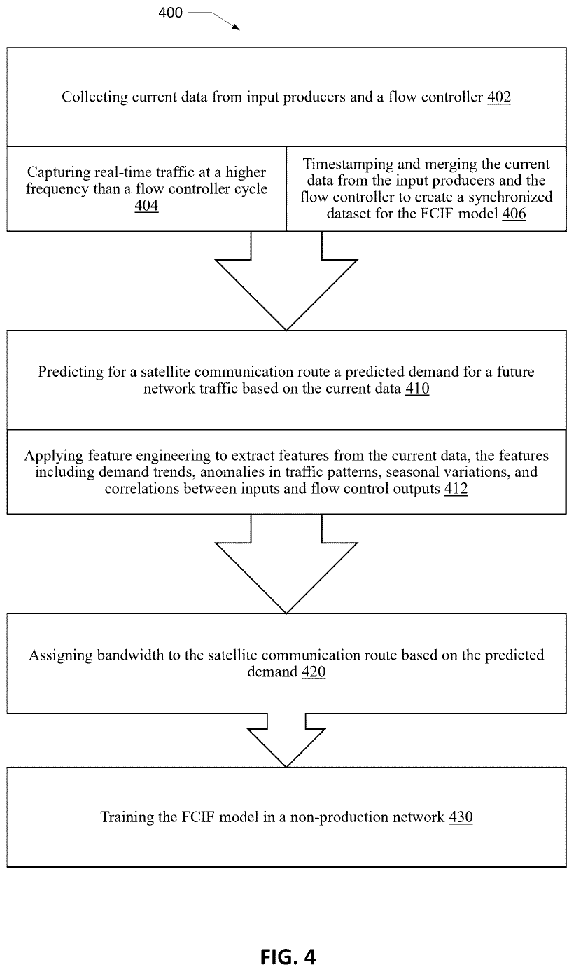

FIG. 4 illustrates a method for optimizing network traffic management through predictive modeling and data collection according to various embodiments.

A method 400 for proactive bandwidth allocation in a satellite communication system for a network traffic is disclosed. Method 400 includes operation 402 for collecting current data from input producers and a flow controller. The data collection process may involve gathering timestamps of traffic inputs, real-time inputs at each flow control cycle, outputs generated by the flow controller, and network conditions. The input producers may track real-time traffic inputs and capture data at a higher frequency than a flow controller cycle per operation 404. The FA may timestamp and merge the data from the input producers and the flow controller to create a synchronized dataset for training the Flow Control Input Farseer (FCIF) model per operation 406. The network conditions may comprise at least one of delay, jitter, and packet loss. This synchronized dataset may be used to predict future network traffic patterns and flow control inputs. The FA's role in data collection and synchronization enables the system to forecast and respond to future network demands effectively.

Method 400 may include operation 410 for predicting for a satellite communication route a predicted demand for a future network traffic based on the current data. Operation 410 may include operation 412. Operation 410 involves the application of feature engineering by the FCIF model to extract significant features from the collected data, which may include demand trends, anomalies in traffic patterns, seasonal variations, and correlations between inputs and flow control outputs. The FCIF model may incorporate an attention mechanism to focus on relevant portions of the input data when making predictions, potentially enhancing the accuracy of the predictions. The FCIF model may utilize machine learning techniques, such as recurrent neural networks (RNNs), long short-term memory (LSTM) networks, and convolutional neural networks (CNNs), to process the engineered features and identify complex relationships between input patterns and flow control behavior. These neural network architectures may allow the model to capture both short-term variations and long-term dependencies in traffic patterns, thereby enabling the prediction of future flow control inputs. The attention mechanism may further improve prediction accuracy by allowing the model to weigh important traffic features more heavily than less significant patterns. This predictive capability may allow the flow controller to proactively adjust bandwidth allocation based on predicted future traffic patterns, potentially improving overall system performance and customer experience. The FCIF model's predictions may include future demand on the network, estimated usage levels across the customer base, and expected input-to-output relationships, which may assist the flow controller in making better-informed decisions about bandwidth allocation.

Method 400 may include operation 420 for assigning bandwidth to the satellite communication route based on the predicted demand. In the context of the satellite communication system, the flow controller may be responsible for assigning bandwidth to terminals based on predicted future network traffic patterns and flow control inputs. This process may involve determining an anticipated demand through methods such as deep packet inspection (DPI) and examination of an upper layer connection type. The flow controller may receive several types of demand inputs, including predicted, anticipated, and advertised demands, to facilitate bandwidth allocation. Input producers, which may include terminals, IP gateways, and nodes on the Internet, may play a role in providing the necessary data for this process. The flow controller may utilize this data to make informed decisions about bandwidth distribution, ensuring that the needs of different user terminals are balanced within a frequency channel. The allocation of bandwidth may occur in bursts at specific times, allowing active user terminals to transmit data according to their allocated time slots. This approach may help in managing varying customer demands and capacity limitations, addressing challenges such as delay in flow control execution and the reactive nature of traditional systems. By incorporating predictive mechanisms, the flow controller may proactively manage bandwidth based on future demand, improving overall system performance and customer experience.

Operation 400 may include operation 430 by focusing on the development and refinement of the Flow Control Input Farseer (FCIF) model by a trainer. The trainer may engage in the initial training of the FCIF model within a non-production network environment. This phase may involve the utilization of historical data collected by the Farseer Agent from both input producers and the flow controller. The data may include timestamps of traffic inputs, real-time inputs at each flow control cycle, outputs generated by the flow controller, and network conditions such as delay, jitter, or packet loss. The trainer may consolidate this data into a synchronized dataset, which may be used to train the FCIF model. The training process may involve the application of supervised learning techniques, where the model learns to map inputs to desired outputs, minimizing the difference between predicted and actual inputs received by the flow controller. Once the initial training is completed, the trained FCIF model may be deployed to the Farseer Agent in a production network. In this setting, the FCIF model may predict future flow control inputs in real-time, allowing the flow controller to proactively adjust bandwidth allocation based on predicted future traffic patterns. This proactive approach may address challenges such as varying customer demands, capacity limitations, and delays in flow control execution, ultimately enhancing the efficiency of bandwidth distribution in the satellite communication system.

Having described preferred embodiments of a system and method (which are intended to be illustrative and not limiting), it is noted that modifications and variations can be made by persons skilled in the art considering the above teachings. It is therefore to be understood that changes may be made in the embodiments disclosed which are within the scope of the invention as outlined by the appended claims. Having thus described aspects of the invention, with the details and particularity required by the patent laws, what is claimed and desired protected by Letters Patent is set forth in the appended claims.

We claim as our invention:

1. A method for proactive bandwidth allocation in a satellite communication system for a network traffic, the method comprising:
collecting, by a Farseer Agent (FA), current data from input producers and a flow controller, wherein the current data comprises traffic inputs, inputs to and outputs generated by the flow controller at each flow control cycle;
predicting, by a Flow Control Input Farseer (FCIF) model, for a satellite communication route a predicted demand for a future network traffic based on the current data; and
assigning, by the flow controller, bandwidth to the satellite communication route based on the predicted demand.

2. The method of claim 1, wherein the network traffic comprises network traffic at a plurality of priorities, the traffic inputs are per priority, and the predicted demand is per priority per satellite communication route.

3. The method of claim 1, wherein the network traffic comprises network traffic for a plurality of Virtual Network Operators (VNOs), the traffic inputs are per VNO, and the predicted demand is per VNO per satellite communication route.

4. The method of claim 1, wherein the current data comprises network conditions comprising at least one of a delay, a jitter, and a packet loss.

5. The method of claim 1, wherein the input producers capture real-time traffic at a higher frequency than a flow controller cycle.

6. The method of claim 1, wherein the FA timestamps and merges the current data from the input producers and the flow controller to create a synchronized dataset for the FCIF model.

7. The method of claim 1, wherein the FCIF model applies feature engineering to extract features from the current data, the features including demand trends, anomalies in traffic patterns, seasonal variations, and correlations between inputs and flow control outputs.

8. The method of claim 1, wherein the FCIF model incorporates an attention mechanism to focus on relevant portions of the current data when making predictions.

9. The method of claim 1, wherein the flow controller determines an anticipated demand based on at least one of deep packet inspection (DPI) and examination of an upper layer connection type.

10. The method of claim 1, wherein the flow controller assigns the bandwidth based on the predicted demand, an anticipated demand, and an advertised demand.

11. The method of claim 1, wherein the input producers comprise an IP gateway capturing real-time traffic at a higher frequency than a flow controller cycle,
the current data comprises an IP gateway current data,
the satellite communication route comprises an outroute, and
the FCIF model infers the predicted demand for the outroute based on the IP gateway current data.

12. The method of claim 1, wherein the input producers comprise a satellite terminal, the current data comprises a satellite terminal current data, the satellite communication route comprises an inroute, and the FCIF model infers the predicted demand for the inroute based on the satellite terminal current data.

13. The method of claim 1, wherein an initial training of the FCIF model is performed in a non-production network and after the initial training the FCIF model is deployed to the FA in a production network.

14. The method of claim 1, wherein the FCIF model trains using historical traffic data and the FCIF model comprises at least one of a recurrent neural network (RNN), a long short-term memory (LSTM) network, and a convolutional neural network (CNN).

15. A system to proactive bandwidth allocation in a satellite communication system for a network traffic, the system comprising:
a Farseer Agent (FA) to collect current data from input producers and a flow controller, wherein the current data comprises traffic inputs, inputs to and outputs generated by the flow controller at each flow control cycle; and
a Flow Control Input Farseer (FCIF) model to predict, for a satellite communication route, a predicted demand for a future network traffic based on the current data;
wherein the flow controller assigns bandwidth to the satellite communication route based on the predicted demand.

16. The system of claim 15, wherein the network traffic comprises network traffic at a plurality of priorities, the traffic inputs are per priority, and the predicted demand is per priority per satellite communication route.

17. The system of claim 15, wherein the network traffic comprises network traffic for a plurality of Virtual Network Operators (VNOs), the traffic inputs are per VNO, and the predicted demand is per VNO per satellite communication route.

18. The system of claim 15, wherein the current data comprises network conditions comprising at least one of a delay, a jitter, and a packet loss.

19. The system of claim 15, wherein the flow controller assigns the bandwidth based on the predicted demand, an anticipated demand, and an advertised demand.

20. The system of claim 15, wherein the input producers comprise an IP gateway capturing real-time traffic at a higher frequency than a flow controller cycle,
the current data comprises an IP gateway current data,
the satellite communication route comprises an outroute, and
the FCIF model infers the predicted demand for the outroute based on the IP gateway current data.
